(19) United States
(12) Patent Application Publication
(10) Pub. No.: US 2005/0173318 A1
(43) Pub. Date: Aug. 11, 2005

(54) Device for cross-current filtration

(76) Inventor: Eduard Hartmann, Schneisingen (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/512,508

(22) PCT Filed: Jun. 17, 2003
(86) PCT No.: PCT/CH03/00391

(30) Foreign Application Priority Data
Jun. 26, 2002 (CH) 1099/02

(51) Int. Cl. B01D 63/00

(52) U.S. Cl. 210/137; 210/321.65; 210/323.2; 210/321.89; 210/456

(57) ABSTRACT

A device for cross-flow filtration includes a plurality of linear filtration modules arranged parallel to each other and branching from a manifold arranged such that a flow transverse to the front surface of the filtration module is generated in front of all filtration modules. A constant flow velocity transverse to the front faces of the filtration modules is achieved by reducing the open cross-section of the manifold in the direction of flow, the reduction being continuous or stepwise. By avoiding the build-up of fibrous clumps, the fault-free operating time of filtration device can be significantly lengthened with relation to a conventionally embodied filtration device.

The invention concerns a device for cross-flow filtration in accordance with the introductory clause of Claim 1.

Systems of this type are advantageously used when molecularly dispersed or colloidally dispersed mixtures of substances that contain solids or suspended substances are to be filtered. Examples of such mixtures of substances are those which are initially obtained in the production of fruit and vegetable juices. These mixtures of substances are then separated by filtration into clear fruit or vegetable juices, on the one hand, and the suspended substances, on the other hand.

WO 01/51186 A1 describes a cross-flow filtration system. This document provides a solution to the problem of removing obstructions of the filtration module by retained solid fractions. Systems of this type are thus affected by the problem that the filter elements can become clogged, so that production must be interrupted before the obstructions can be removed. However, production shutdowns are undesirable.

WO 00/03794 A1 describes a cross-flow filtration system of the type specified in the introductory clause of Claim 1, in which a device for mixing fluids is connected upstream of the filter element. This solves the problem where some of the parallel membrane channels of the filter element become obstructed when flushing of the filter element is started. In some of the specific embodiments, a precirculation system, from which the individual membrane channels branch off, is installed upstream of the filter element.

WO94/29007 A1 proposes a method for cleaning filtration modules to solve the problem that fibrous components of the mixture to be filtrated are deposited on the front surfaces of the individual parallel membrane channels when the mixture to be filtered has a high fiber component. These types of deposits of fibers are detached by reversing the direction of flow in the filtration module. The reversal of the direction of flow means an undesirable interference with the continuous production process and reduces the efficiency of the filtration system.

U.S. Pat. No. 6,221,249 B1 and U.S. Pat. No. 3,387,270 B1 describe filtration systems in which the tangential velocity of the medium to be filtered on a membrane remains constant over the length of the membrane. This is accomplished by constructing the channel for the passage of the medium to be filtered with a cross section that continuously decreases from the inlet of the filtration module to its outlet.

The object of the invention is to develop a device for cross-flow filtration that is suitable for processing mixtures of substances with a high fiber content and that reduces the risk of clogging of membrane channels by fibers so substantially that production efficiency is increased.

In accordance with the invention, this object is achieved by the features of Claim 1. Advantageous refinements of the invention are specified in the dependent claims.

Specific embodiments of the invention are explained in greater detail below with reference to the drawings.

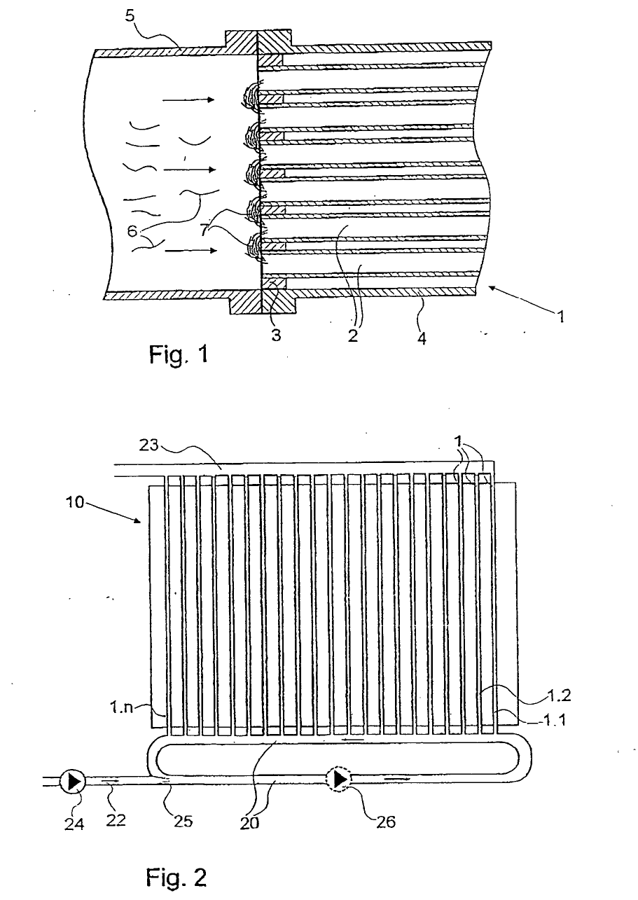

FIG. 1 shows a schematic drawing for illustrating the problem to be solved.

FIG. 2 shows a first schematic drawing of a filtration system in accordance with the invention.

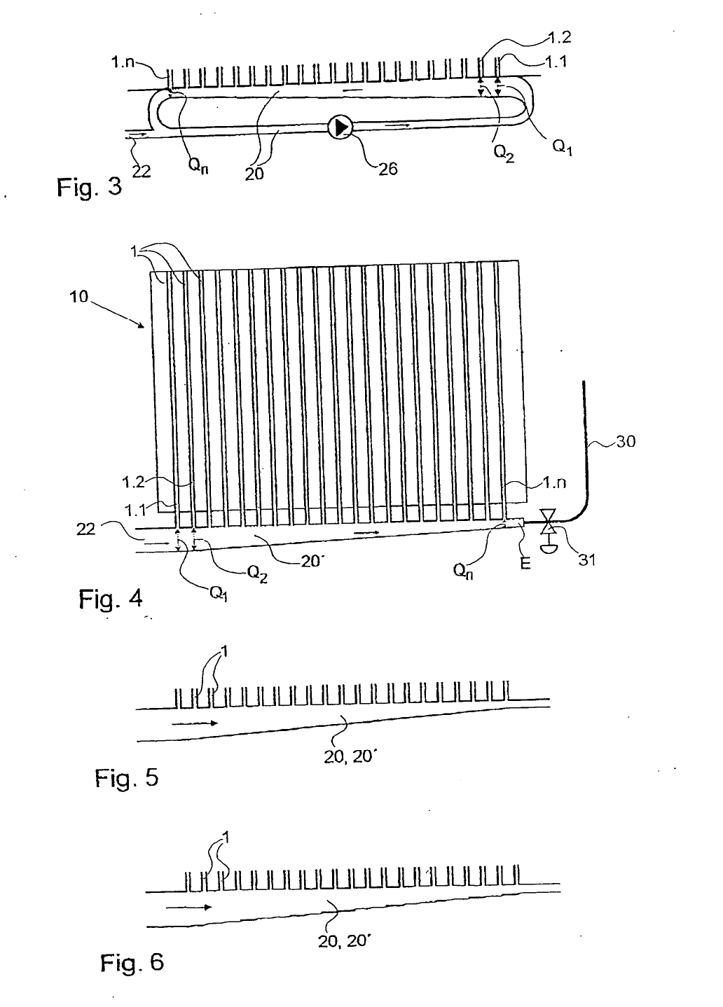

FIG. 3 shows an advantageous embodiment of a manifold.

FIG. 4 shows a second schematic drawing of a filtration system in accordance with the invention.

FIG. 5 shows a second embodiment of a manifold.

FIG. 6 shows a third embodiment.

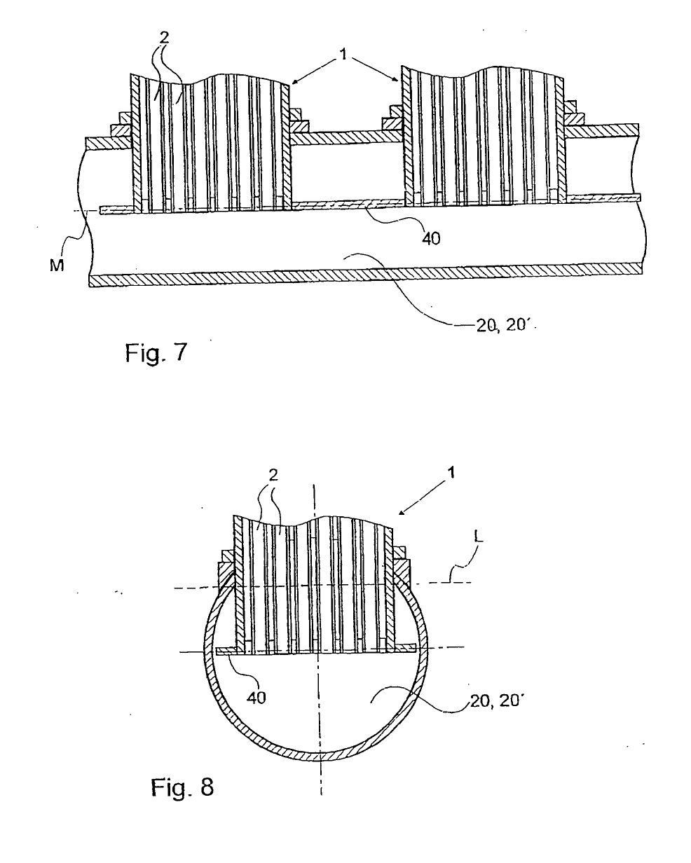

FIGS. 7 and 8 show a special embodiment in longitudinal section and in cross section, respectively.

FIG. 1 shows a longitudinal section of a bundle of membrane channels. 1 represents a filtration module of a device for cross-flow filtration, in which several membrane channels 2 are combined into a bundle, which together form the filtration module 1. Filtration modules 1 of this type are called linear modules. The membrane channels 2 are fastened in a module housing 4 by a sealing compound 3 at the front surfaces. The mixture to be filtered is supplied to the filtration module 1 by a connecting pipe 5. The direction of flow of the mixture to be filtered is indicated by arrows. If the mixture to be filtered contains large numbers of fibers 6, clumps 7 of fibers that consist of large numbers of fibers can build up on the ring-shaped front surfaces of the membrane channels 2 and on the parts of the sealing compound 3 that surround them. This inevitably occurs, because zones in which practically no flow occurs are present in front of the sealing compound 3 between adjacent membrane channels 2. In this respect, the front surface of the filtration module acts as a perforated screen. From the start of the filtration process, fibers 6 form clumps 7 of this type, which become larger and larger and more and more compact in the course of the filtration process.

Since this inevitably results in a reduction of the free inlet cross section of the individual membrane channels 2, the velocity of flow at the now reduced inlet cross section increases if the pump that is pumping the mixture to be filtered is operating at constant power. If clumps 7 of fibers have reached a certain size and compactness, individual clumps 7 of fibers are necessarily entrained into the inside of a membrane channel 2. Individual membrane channels 2 can thus become clogged by clumps 7 of fibers in this way. This necessarily leads to a decrease in filtration efficiency. More or less all of the membrane channels can eventually become clogged.

In WO 94/29007 A1, it was proposed that clumps 7 of fibers that have already built up be washed away by periodically reversing the direction of flow. However, the effectiveness of this method is limited, because even when the flow is reversed, there are zones with no flow on the front surfaces of the membrane channels 2, so that clumps 7 of fibers that have formed are not reliably washed away. The clumps 7 of fibers can also be so compact that even though they are washed away, they remain as cohesive clumps 7 of fibers, i.e., they are not broken up into individual fibers 6. Therefore, flow reversal to wash away the clumps of fibers is not always useful, because the clumps can continue to clog the membrane channels 2 even when the direction of flow is reversed.

In addition, more or less trouble-free operation of the filtration system requires that the operating personnel have a great deal of experience. Since the mixture to be filtered has a highly variable fiber fraction, depending on the initial product, it is scarcely possible to predict when flow reversal is actually necessary, since the increasing buildup of clumps 7 of fibers is not visible from the outside. It has also been found that it is not practical to use the pressure drop through the filtration module 1 as a criterion for the increasing buildup of clumps 7 of fibers.

The actual goal of the invention is thus to prevent the buildup of these clumps 7 of fibers on the front ends of the filtration modules 1 completely, if possible, or to the greatest possible extent. In accordance with the general idea of the invention, the solution to the stated problem consists in producing a flow that runs transversely to the front surfaces of the filtration modules 1 at the front ends of the filtration modules. As a result of this flow transverse to the front surfaces of the filtration modules 1, there are no regions on these front surfaces in which practically no flow is occurring. It was found that this can prevent the buildup of clumps 7 of fibers in a strikingly simple way.

FIG. 2 shows a first schematic drawing of the solution in accordance with the invention. It shows a filter unit 10 that consists of parallel-connected filtration modules 1. Each of these filtration modules 1 can be an individual membrane channel 2 (FIG. 1) or a bundle of several parallel membrane channels 2, as shown in FIG. 1. A manifold 20 is connected to the inlet side of the filter unit 10. From this manifold 20, there is a connection to each filtration module 1. The manifold 20 of this embodiment is a closed circulation system, which in itself is already well known, and to which the mixture to be filtered is supplied through a feed pipe 22.

For the sake of completeness, FIG. 2 also shows a discharge pipe 23, in which the retentate leaving the filtration module 1 is collected and, for example, conveyed to a batch tank (not shown), as is well known.

A feed pump 24, which pumps the mixture to be filtered and produces the pressure necessary for filtration, is installed in the feed pipe 22, as is also well known.

The manifold 20 contains means to force the circulation of the mixture to be filtered in the manifold 20. These means can consist, for example, of an injector 25 or a circulating pump 26, as is also well known.

In accordance with the invention, the manifold 20 is designed in such a way that a flow develops transversely to the front surfaces of the filtration modules 1 at the front ends of the individual filtration modules 1. This is accomplished by means of the injector 25 or the circulating pump 26. Since these two units can be alternatively present, they are drawn in broken lines in FIG. 2. The flow transverse to the front surfaces of the filtration modules 1 reliably prevents the buildup of clumps 7 of fibers (FIG. 1) at the inlets of the individual filtration modules 1.

It is advantageous if the flow transverse to the front surfaces of the filtration modules 1 is approximately constant at all of the filtration modules 1. This is accomplished by providing for the cross section Q of the manifold 20 to decrease from the branch to the first filtration module 1.1 to the branch to the last filtration module 1.n, as shown in FIG. 3. The cross section Q has the value Q₁ at the branch to the first filtration module 1.1, the value Q₂ at the branch to the second filtration module 1.2, and the value Qₙ at the branch to the last filtration module 1.n.

It is advantageous if the decrease in the cross section Q of the manifold 20 is designed in such a way that the flow velocity v in the manifold 20 remains constant over the entire length of the manifold 20 from the branch to the first filtration module 1.1 to the branch to the last filtration module 1.n. This ensures approximately constant flow transverse to the front surfaces of the filtration modules 1 over the length of the manifold from the branch to the first filtration module 1.1 to the branch to the last filtration module 1.n. In this way, the buildup of clumps 7 of fibers (FIG. 1) at the inlets of the individual filtration modules 1 is even more reliably prevented.

The constant flow velocity is achieved by making the cross section Q smaller at each branch. If the cross section Q has the value Q₀ before the branch to the first filtration module 1.1, the cross section Q after the branch to the first filtration module 1.1 is reduced by a value Qₘ, for example, by 1 cm². The cross section decreases correspondingly after each branch by the amount Qₘ. This ensures that the flow velocity transverse to the front surfaces of the filtration modules 1 remains approximately constant from the first branch to the last branch. The magnitude of the value Qₘ is determined not only by the cross section of the individual filtration modules but also by the ratio of the flow velocity transverse to the filtration modules 1 to the flow velocity through the filtration modules 1.

The pump 26 is one means of adjusting the flow velocity transverse to the front surfaces of the filtration modules 1. If its speed is increased, the flow velocity increases, and if its speed is reduced, the flow velocity decreases. In this respect, the pump 26 is a more advantageous means than the injector 25.

FIG. 4 shows a manifold 20′ that does not form a closed circulation system with a pump 21, but rather is a linear manifold. Consequently, it has a dead end E, at which no flow occurs transversely to the last branch. To prevent a clump 7 of fibers (FIG. 1) from building up on the last filtration module 1.n, an additional discharge line 30, which, for example, leads back to the batch tank (not shown), ensures that transverse flow occurs even at the branch to the last filtration module 1.n. The end E is thus no longer a dead end.

It is advantageous to install a throttle valve 31 in this discharge line 30 for adjusting the flow velocity transverse to the last branch. If this throttle valve 31 is adjustable, it is advantageously possible to vary the magnitude of the flow velocity v_{E} that prevails at the end E of the manifold 20′. The flow velocity v_{E} can thus be increased or decreased according to the fiber fraction of the mixture to be filtered. Accordingly, the throttle valve 31 serves as the means of adjusting the flow velocity transverse to the front surfaces of the filtration modules 1.

FIG. 5 shows a manifold 20, 20′, in which the clear cross section of the manifold 20, 20′ continuously decreases in the direction of flow. FIG. 5 shows an alternative embodiment of the manifold 20, 20′, in which the clear cross section of the manifold 20, 20′ decreases incrementally.

It is advantageous if the flow velocity through the manifold 20, 20′, which can be adjusted by the throttle valve 31 or by the speed of the pump 26, is significantly greater than the flow velocity through the individual filtration modules 1. A velocity ratio of greater than 3 to 1 was found to be especially effective.

The linear manifold 20′ can also be designed in such a way that its cross section is constant, as is shown in FIG. 2 in the case of the manifold 20. However, it is then necessary to ensure that the flow velocity v_{E} that prevails at the end E of the manifold 20′ continues to be sufficiently high to prevent the buildup of clumps 7 of fibers (FIG. 1).

FIGS. 7 and 8 show an embodiment for connecting filtration modules 1 of the type already shown in FIG. 1, in which each filtration module 1 consists of a bundle of membrane channels 2 arranged parallel to one another. FIG. 6 shows a longitudinal section through the manifold 20, 20′, whereas FIG. 7 shows a cross section. In FIG. 7, the central longitudinal axis of the manifold 20, 20′ is denoted by the letter M.

The special feature of this embodiment is that the front surfaces of the filtration modules 1 are located more or less centrally in the cross section of the manifold 20, 20′. In the center of the manifold 20, 20′ there is a perforated partition plate 40, which is arranged flush with the front surfaces of the filtration modules 1. Flanges, which are used to mount the individual filtration modules 1 on the manifold 20, 20′, are indicated only schematically.

The partition plate 40 produces two separate flow paths in the manifold 20, 20′. The filtration modules 1 extend into the upper flow path, which reduces the cross section of free flow through the individual filtration modules 1. This results in strongly disturbed flow in this region, which leads to turbulence. The lower flow path has an undisturbed semicircular cross section, so that undisturbed linear flow occurs here.

This is related to the fact that it is advantageous, for reasons of stability and cost, if the manifold 20, 20′ consists of a tube, i.e., if the manifold 20, 20′ has a circular cross section. If the filtration modules 1 were inserted in the manifolds 20, 20′ in such a way that their front surfaces lay on a line L, which is drawn as a broken line, this would have the disadvantage that the aforementioned turbulence would occur in the region of the front surfaces extending into the free cross section of the manifold 20, 20′.

In the case of a rectangular cross section of the manifold 20, 20′, this would not be necessary, but then the wall thickness of the manifold 20, 20′ would have to be greater to be sufficiently stable.

The invention described above in different variants and embodiments has been found to be especially effective when the buildup of clumps 7 of fibers (FIG. 1) on the front surfaces of the filtration modules 1 is to be prevented. The invention can be used especially effectively when the mixture to be filtered contains organic fibers of stems, cores, cell walls, rinds, and leaves, such as occurs in the production of juices from vegetables, fruits, roots, etc. It can be used equally well in the filtration of sewage, sludges, biomasses, and similar products that contain fibrous materials.

However, it is also significant that the clogging of membrane channels 2 by clumps 7 of fibers can lead to a situation in which it is no longer possible to unclog the clogged membrane channels 2. The membrane channels 2 then become unusable and must be replaced. This would result in considerable financial loss if membrane channels become clogged by clumps 7 of fibers. This type of financial loss is thus also prevented by the invention.

1-10. (canceled)

11. An apparatus for cross-flow filtration, the apparatus comprising:
a plurality of linear filtration modules arranged in parallel and having respective front ends with respective front surfaces which are aligned in a linear direction; and
a flow distribution manifold connected to said front ends and arranged so that a flow having a flow velocity in said linear direction is present at the front ends of all of said modules.

12. An apparatus as in claim 11 wherein said manifold is designed so that said flow velocity which is constant at the front ends of all of said modules.

13. An apparatus as in claim 12 wherein said manifold has a cross-section that decreases in the flow direction.

14. An apparatus as in claim 13 wherein said cross-section decreases continuously in said flow direction.

15. An apparatus as in claim 13 wherein said cross-section decreases incrementally in said flow direction.

16. An apparatus as in claim 11 further comprising means for adjusting the flow velocity in said linear direction.

17. An apparatus as in claim 16 further comprising a return loop connected to opposite ends of said manifold, said means for adjusting flow velocity comprising a pump in said loop.

18. An apparatus as in claim 16 wherein said manifold has an end downstream in said linear direction, said means for adjusting flow velocity comprising a discharge line at said end of said manifold, and a throttle valve in said discharge line.

19. An apparatus as in claim 11 wherein said manifold has a round cross-section.

20. An apparatus as in claim 9 wherein said front surfaces of said modules are arranged approximately on a diameter of said manifold, said apparatus further comprising a partition plate arranged in said manifold flushly with said front surfaces.
